(19) United States
(12) Patent Application Publication
(10) Pub. No.: US 2022/0075920 A1
(43) Pub. Date: Mar. 10, 2022

(54) Automated Debug of Falsified Power-Aware Formal Properties using Static Checker Results

(71) Applicant: Synopsys, Inc., Mountain View, CA (US)

(72) Inventors: Sachin Bansal, Noida (IN); Bhaskar Pal, Bangalore (IN); Kamalesh Ghosh, Bangalore (IN); Tushar Parikh, Newton, MA (US); Soumik Das Choudhury, Bangalore (IN); Hasindu Ramanayake, Kundasale (LK)

(21) Appl. No.: 17/463,040

(22) Filed: Aug. 31, 2021

Related U.S. Application Data
(60) Provisional application No. 63/076,701, filed on Sep. 10, 2020.

(51) Int. Cl. G06F 30/3323; G06F 30/3315

(52) U.S. Cl. CPC G06F 30/3323; G06F 2119/06; G06F 30/3315

(57) ABSTRACT

A power intent specification specifies the desired power intent for a design of an integrated circuit, for example the states of the power domains under different conditions. Power-aware formal properties describe desired behaviors specified by the power intent specification. Falsified power-aware formal properties indicate that the design does not exhibit the desired behavior. In addition, a debug context database contains debug contexts for static-check violations resulting from power-aware static checking of the design. Static checking checks for compliance with the power intent specification based on a static structure of the design. Falsified power-aware formal properties ae matched against the static-check violations. A data structure is generated, associating debug contexts for the matching static-check violations as possible causes of the falsified power-aware formal properties.

### RELATED APPLICATION

This application claims the benefit of U.S. Provisional Application No. 63/076,701, filed Sep. 10, 2020, which is incorporated by reference in its entirety.

### TECHNICAL FIELD

The present disclosure relates to formal verification of power-aware properties.

### BACKGROUND

Power management and reducing power consumption in integrated circuits (chips) is increasingly important. Different techniques may be used to reduce power consumption. One technique is to use different power domains within the integrated circuit. Power domains may be turned on when needed and idled or turned off when not needed, thus reducing power consumption. This power management functionality is often referred to as the power intent of the chip.

Since defects in this power management functionality can cause integrated circuits to malfunction, integrated circuits should be verified during the design phase to ensure that this functionality is operating correctly. If errors in the power intent are detected, the root cause of the error should be identified and corrected.

### SUMMARY

In one approach, both formal verification and static checking are used to verify the power intent of a design of an integrated circuit. Violations detected by formal verification are referred to as falsified power-aware formal properties. These are matched against violations detected by the static checking to determine possible causes of the falsified power-aware formal properties. The falsified power-aware formal properties are annotated with information about the matching static-check violations.

In another aspect, a power intent specification specifies the desired power intent for a design of an integrated circuit, for example the states of the power domains under different conditions. Power-aware formal properties describe desired behaviors specified by the power intent specification. Falsified power-aware formal properties indicate that the design does not exhibit the desired behavior. In addition, a debug context database contains debug contexts for static-check violations resulting from power-aware static checking of the design. Static checking checks for compliance with the power intent specification based on a static structure of the design. Falsified power-aware formal properties ae matched against the static-check violations. A data structure is generated, associating debug contexts for the matching static-check violations as possible causes of the falsified power-aware formal properties.

Other aspects include components, devices, systems, improvements, methods, processes, applications, computer readable mediums, and other technologies related to any of the above.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1A is a diagram of automated debug of falsified power-aware formal properties.

FIG. 1B is a flow diagram of an example process for the automated debug framework of FIG. 1A.

FIG. 1C is a block diagram of an embodiment of the automated debug framework of FIG. 1A.

FIG. 2A shows a summary report of violations from a static checker.

FIG. 2B shows detailed descriptions of two static-check violations.

FIG. 3 shows debug contexts for the static-check violations of FIG. 2B.

FIG. 4A is a circuit representation of the power intent of a failed formal property.

FIG. 4B shows a UPF specification of the power intent.

FIG. 5A is a circuit representation of a power intent with parallel resolution.

FIG. 5B shows formal verification results for the power intent of FIG. 5A.

FIG. 6 is a diagram of an automated debug framework that adapts based on user feedback.

FIG. 7 depicts a flowchart of various processes used during the design and manufacture of an integrated circuit in accordance with some embodiments of the present disclosure.

FIG. 8 depicts a diagram of an example computer system in which embodiments of the present disclosure may operate.

### DETAILED DESCRIPTION

Aspects of the present disclosure relate to automated debug of falsified power-aware formal properties using static checker results.

Modern designs of integrated circuits may partition an integrated circuit into different power domains. The power domains may be switched ON or OFF (or into other states) depending on the operation of the integrated circuit. The states of the power domains under different conditions is referred to as the power intent and it may be defined in a power intent specification, for example using the UPF (Unified Power Format) standard.

Formal verification uses formal mathematical and logic analysis to verify the functional logic of an integrated circuit design. VC-Formal from Synopsys is an EDA software tool that carries out formal verification. In formal verification, a formal property is used to describe the desired behavior/function. A rigorous analysis is then used to formally prove whether or not the circuit design adheres to the behavior described by the property. Because the analysis is rigorous, it is also exhaustive to cover all possible operations of the circuit design. If the circuit design does not adhere to the behavior described by the property, the property is falsified. EDA tools typically report falsified properties as issues (errors) to the user.

In recent times, there has been an increasing need to exhaustively verify power-aware behavior, i.e., behavior of the circuit that involves the power intent. An example of power-aware behavior is: a power switch output supply is driven by an input supply when the ON state expression is true. The design may be verified for compliance with this behavior. “Power-aware” is sometimes referred to as “low power” because a common goal of power-aware designs is to reduce power consumption. Formal verification may be used to test power-aware behavior by creating formal properties for these behaviors. For convenience, these properties will be referred to as power-aware formal properties. Formal verification tools may then report falsified power-aware formal properties.

The debug of falsified power-aware formal properties requires domain knowledge of both formal verification as well as power-aware design. However, formal verification is typically run by verification engineers, who may not be familiar with power-aware principles. As a result, debugging falsified power-aware formal properties to find the root cause of the error can be a time-consuming manual task.

The techniques described below automate the debug of falsified power-aware formal properties by combining the results of the formal verification with the results of static checking.

Static checking verifies a circuit design based on the static structure of the circuit design. For example, VC-Static Low Power (VCLP) from Synopsys is a power-aware static checking EDA software tool used to verify the correctness, completeness and consistency of the power intent of the circuit design based on its static structure. This type of static check will be referred to as a power-aware static check or a power intent static check. Power-aware static checkers use the circuit design data and the power intent specification to verify the power intent of a circuit design. If issues are detected, static checkers typically report a listing of violations. For each violation, the report typically states the type of power intent problem present and identifies the relevant locations (nodes) in the circuit design and/or in the power intent.

As a circuit design is being developed, violations from the static checking are collected into a database. For convenience, this will be referred to as the context debug database, because it will be used to provide context for the debug of falsified properties. Falsified properties from the formal verification are matched against the violations in the context debug database. For example, the nodes involved in a falsified property may be matched against the nodes for different static-check violations in the database. Based on this, additional context for the falsified property may be retrieved from the context debug database, which can help in determining the cause of the falsified property.

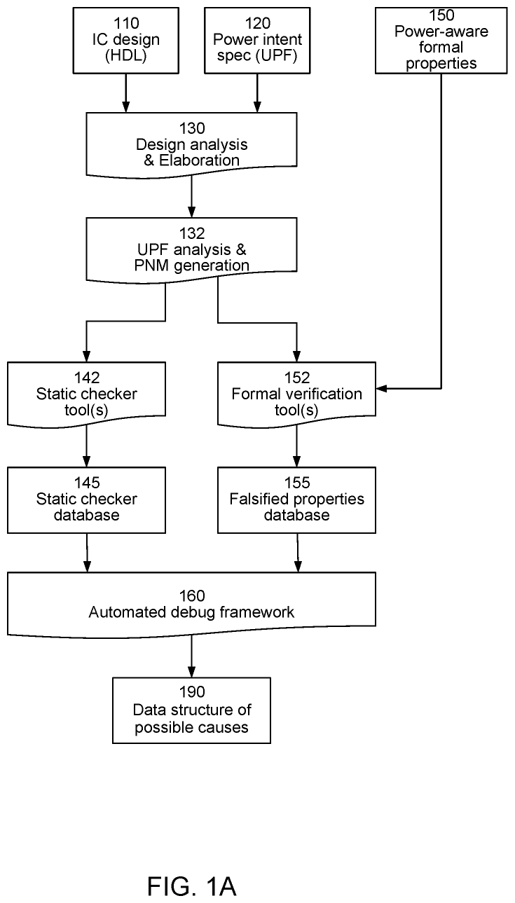

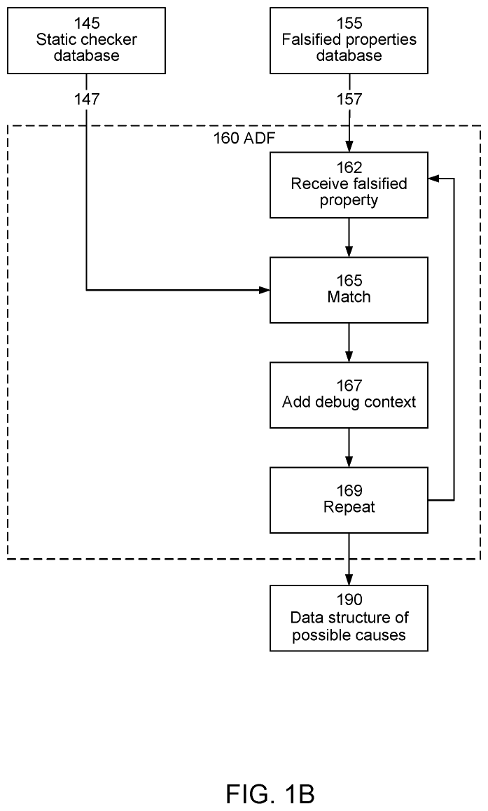

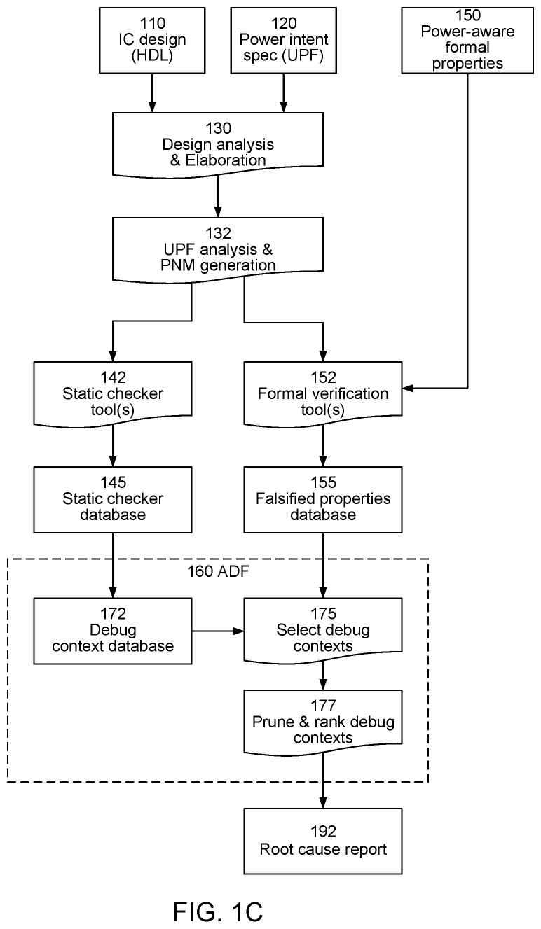

FIG. 1A is a diagram of automated debug of falsified power-aware formal properties. Consider first the automated debug framework 160 and its two inputs: static check database 145 and falsified properties database 155. The static checker database 145 contains the static-check violations and associated information. It is created from analysis information produced by a power-aware static checker tool(s) 142. The falsified properties (failed properties) database 155 contains the falsified power-aware formal properties. It is created from the results produced by the formal verification tool(s) 152. The contents of the databases 145 and 155 may change over time, for example as the design 110 and/or power intent specification 120 are evolved during the design cycle.

The automated debug framework (ADF) 160 is a specialized software module that compares the violations in the failed properties database 155 and the static checker database 145, producing a data structure 190 of possible causes of the falsified power-aware formal properties. In some embodiments, the power-aware static checking 142-145, the power-aware formal verification 152-155 and the automated debug framework 160 are implemented as an integrated flow. The ADF 160 may have direct access to the two databases 145, 155 and the underlying information. Examples of output 190 include reports for use by humans or by other EDA tools. The output 190 may also be used to enhance or annotate the failed properties database 155. For example, possible causes may be added to the database 155.

FIG. 1B is a flow diagram of an example of this process. ADF 160 has access 157, 147 to both the failed properties database 155 and the static checker database 145. It receives 162 a falsified power-aware formal property from the failed properties database 155. The falsified property is matched 165 against static-check violations from the static checker database 145. For example, matching may be based on which nodes in the design or the power intent are involved. If a falsified property and a static-check violation both involve the same nodes or have substantial overlap of nodes, then the two may be matched.

The static checker database 145 contains additional information about the static-check violations, such as text descriptions of the cause of the violation. This information can provide additional context for the matching falsified property. For example, if a falsified property involves the same nodes as a static-check violation, and the cause of the static-check violation is xyz, then the cause of the falsified property may also be xyz. This context may be useful for debugging the falsified property, so it is referred to as debug context. The debug context is added 167 to the data structure 190 in a manner that associates the debug context as a possible cause of the falsified property.

This process is repeated 169 for the falsified properties in the database 155. The falsified properties may be processed sequentially or in parallel. In some cases, similar or related falsified properties may be grouped together and processed as a group, or the results may be grouped together. For example, if several falsified properties are all associated with the same root cause, this may be presented as a single root cause associated with the group of falsified properties, rather than presenting each falsified property separately.

The automated debug framework 160 explores the static checker database 145 to find the relevant cause(s) for falsified power-aware formal properties. It may systematically prune the various aspects of falsified formal properties to find the relevant cause(s) based on information in the static checker database 145. By accessing the static checker database 145, the ADF 160 incorporates the low power domain knowledge-based intelligence. As described in more detail below, it may also incorporate user feedback to dynamically improve its decision-making to find the relevant causes.

Returning to FIG. 1A, the boxes above databases 145, 155 show possible flows for creating those databases. The circuit design is captured by design files 110, for example HDL files. The design includes multiple power domains, and the desired power intent is captured by the power intent specification 120, for example UPF files. This specifies the states of the power domains under different conditions.

Modules 130 and 132 process these inputs. Module 130 includes analysis of the design 110 and elaboration (exploration) of the design 110. Module 132 includes analysis of the power intent specification 120. It also converts the power intent specification from UPF form to PNM form. Here, PNM stands for power network model, which captures the power intent as a functional model to capture the supply state of various supplies by modelling power switch strategies, resolution functions, add power state, etc. The PNM may be used by a power-aware verification checker (e.g., simulation engine, formal verification engine).

After module 132, the left branch is power-aware static checking and the right branch is power-aware formal verification. For the static checking, a static checker tool 142 uses the circuit design and power intent (in UPF form) as input, analyzes the circuit design for compliance with the power intent, and produces static-check violations that are collected as database 145.

For the formal verification, power-aware formal properties 150 are provided, for example by the user based on the power intent specification and circuit design. A formal verification tool 152 then uses the PNM to analyze the circuit design for compliance with the power intent, and produces violations (falsified properties) that are collected as database 155.

FIG. 1C is a block diagram of an embodiment of the automated debug framework of FIG. 1A. In this example, the ADF 160 creates a debug context database (DCB) 172 from the static checker database 145, rather than accessing the database 145 directly. It selects 175 debug contexts from the DCB 172 for the falsified properties in database 155. The selected debug contexts are pruned and/or ranked 177 to narrow the possible causes of the falsified properties. These are described in more detail below, using UPF as the format for the power intent specification 120, VCLP as the static checker tool 142 and VC-Formal as the formal verification tool 152, although other tools and formats may also be used. The resulting data structure is a root cause report 192.

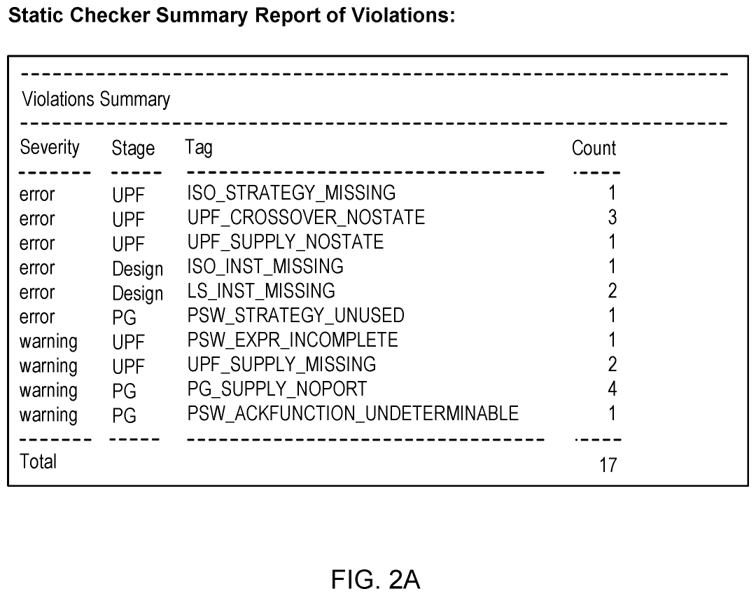

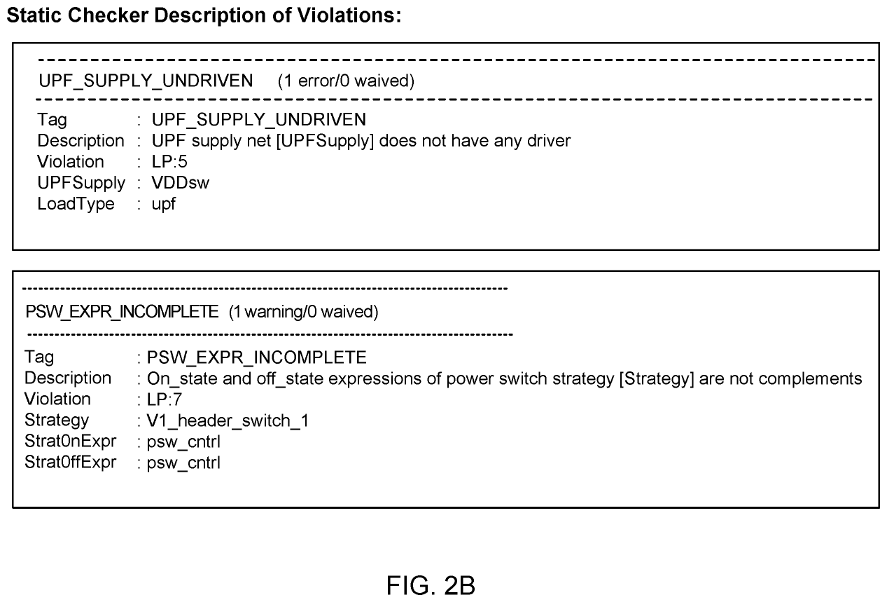

Consider first the static checker tool 142 and static checker database 145. VCLP is a static power-aware verification tool which uses UPF along with circuit design information to verify correctness, completeness and consistency of power intent for a given design. VCLP uses design connectivity and auxiliary inputs (UPF, clock, etc.) to identify different power intent issues in the design in the form of a violation report. A typical VCLP violation report contains a summary of violations, as shown in FIG. 2A, and a detailed description of each violation, as shown in FIG. 2B.

The summary report of FIG. 2A includes the following columns: Tag indicates the type of violation. Severity describes the severity of the violation, in this example rated either as an error or a warning. Stage identifies where the violation occurred. UPF means the violation is an issue with the power intent specification, Design means the violation is an issue with the circuit design, and PG means the violation is an issue with the PG (power-ground) netlist design which has power-ground connections in the design circuitry itself. Count is the number of violations of the specified type.

FIG. 2B shows additional descriptions of two violations. The top violation is identified by Tag UPF_SUPPLY_UNDRIVEN. There is 1 error, which has not been waived. The description indicates that the violation is that a UPF supply net does not have a driver. This is a UPF error, meaning that the driver is not present in the UPF for a given supply. Nodes such as UPFSupply and LoadType are identified in the static checker itself from UPF information. These are UPF nodes.

The bottom violation is identified by Tag PSW_EXPRE_INCOMPLETE. It is a warning and is not waived. The violation is that the ON conditions and OFF conditions for a power switch strategy are not complements, meaning either there are some conditions that are defined as both ON and OFF or as neither ON nor OFF. This is also a UPF violation. UPF nodes are identified by the static checker from UPF information.

The descriptions in FIG. 2B show only some of the information available to the ADF 160. The static check database 145 includes additional information and the ADF 160 may also have access to other sources of information, such as the design database 110. For example, violations are also associated with sets of Design/Power Intent objects, which are captured in debug fields. Design objects refer to the circuitry itself, such as instance, pins, ports, and nets in the HDL design itself. Power Intent (UPF) objects refer to the power intent and power specification such as power domain, supply net, supply port, voltage value, supply state, various strategies (isolation, level-shifter, power switch etc.), etc. Debug fields are stored in the static checker database and they have back references to actual Design/Power intent objects. Thus, the power-aware static checker database is a mapping of Design/Power Intent objects to power-aware issues, where the mapping is accomplished with the help of violations.

In FIG. 1C, debug context 172 is created by extracting information from the power-aware static checker database 145. Each violation in the static checker database 145 represents some issues in the power intent specification (UPF) or in the circuit design. The violations have debug fields which capture the Design/Power Intent nodes associated with the issue. In this example, Design nodes are nodes from the circuit topology, and Power Intent nodes are nodes from a power network model expressing the power intent. In other words, these debug fields capture the context of an issue associated with each violation. This debug context is used for systematic pruning of various aspects of power-aware formal property falsification to find the relevant cause(s).

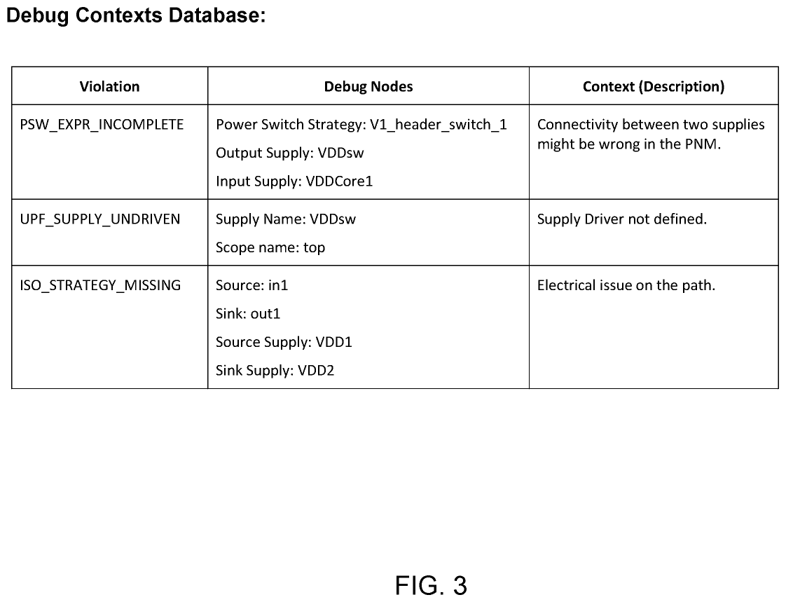

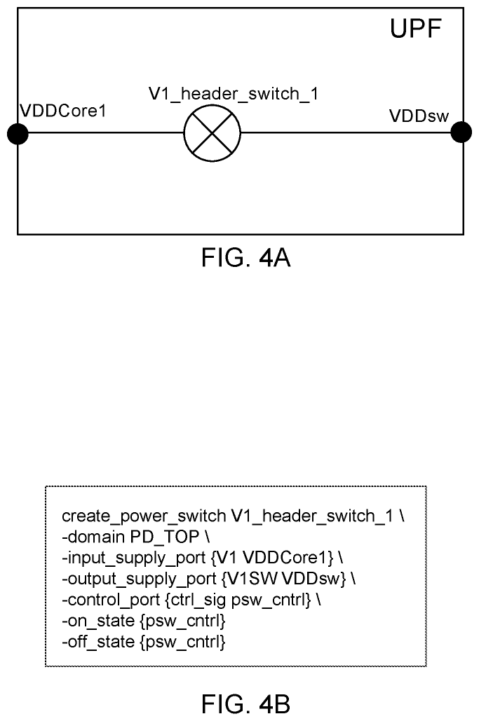

For example, information for the violations PSW_EXPR_INCOMPLETE and UPF_SUPPLY_UNDRIVEN from FIG. 2B are extracted to create the debug contexts shown in FIG. 3. FIG. 3 also includes debug contexts for the violation ISO_STRATEGY_MISSING, which is not shown in FIG. 2B but will be used in the example of FIG. 4. The debug context may include the debug nodes and a description of the issue. The debug context database (DCB) is a database of debug contexts for violations in the static checker database. The debug contexts database uses debug fields (e.g., both Design and Power Intent objects) and the context in which the violation is generated. The context captures domain knowledge and heuristics.

In FIG. 1C, the formal verification tool 152 generates a set of falsified or failed properties 155. Each failed power-aware formal property also has Design/Power Intent nodes attached to it. The debug context database 172 is used to map these nodes to possible issues in the design.

Consider the example of a falsified power-aware formal property. In this example, the power-aware formal property is:

add_cc -dest VDDsw -src VDDCore1 -enable {psw_cntrl==1}-lpa_type LPA_SUPPLY
This property checks the structural and functional connectivity between two supplies VDDCore1 and VDDsw when the enable condition holds true. However, in this example situation, the property is falsified because VDDsw is OFF when VDDCore1 is FULL_ON.

The UPF power intent for this circuit specifies that both supplies are connected through a power switch, as shown pictorially in FIG. 4A. The corresponding UPF specification of the power intent is shown in FIG. 4B.

The fanin cone of supply VDDsw given in the formal property has these Design/Power Intent nodes:
VDDsw
V1_header_switch_1 (Power Switch Strategy)
VDDCore1

In this case, the UPF node VDDsw present in the path of the power-aware formal property can be mapped to the violation UPF_SUPPLY_UNDRIVEN from FIG. 3. Also, the power switch strategy V1_header_switch_1 can be mapped to violation PSW_EXPR_INCOMPLETE from FIG. 3. Two other nodes “VDDsw” and “VDDCore1” also match with violation PSW_EXPR_INCOMPLETE. UPF_SUPPLY_UNDRIVEN suggests that the VDDsw supply is undriven. PSW_EXPR_INCOMPLETE suggests that the connectivity of VDDsw is broken. These are two possible causes of the falsified formal property. They were selected 175 by matching Design/Power Intent nodes from the falsified formal property against Design/Power Intent nodes for the violations in the debug context database 172.

Formal properties can have many Design/Power Intent nodes which may map to multiple different violations present in the debug context database. Based on knowledge about the power-aware design domain, the different debug contexts may be pruned and/or ranked 177 in a priority order for selecting the more likely causes which could have caused the property falsification.

Continuing the example above, the falsified property has three Design/Power Intent nodes: VDDsw, V1_header_switch_1, and VDDCore1. Comparing to the three violations shown in FIG. 3, PSW_EXPR_INCOMPLETE has three matching nodes, UPF_SUPPLY_UNDRIVEN has one matching node, and ISO_STRATEGY_MISSING has zero matching nodes. Based on the number of matching nodes, ISO_STRATEGY_MISSING is pruned, leaving the two other violations and their corresponding contexts. In this example, PSW_EXPR_INCOMPLETE is ranked above UPF_SUPPLY_UNDRIVEN based on the number of matching nodes.

There can be many types of relationships between causes. Hierarchical root causes may be used to rank causes.

Hierarchical: There can be nested causes for a falsified property. One cause can be the effect of another cause. Hierarchical causes are demonstrated in the example of FIG. 4 above. For example:
Root cause: PSW_EXPR_INCOMPLETE: VDDsw was undriven as power switch strategy has some issue causing no connection between two supplies. This is the cause for UPF_SUPPLY_UNDRIVEN.
Resulting effect: UPF_SUPPLY_UNDRIVEN: VDDsw was undriven leads to broken connectivity between VDDCore1 and VDDsw.

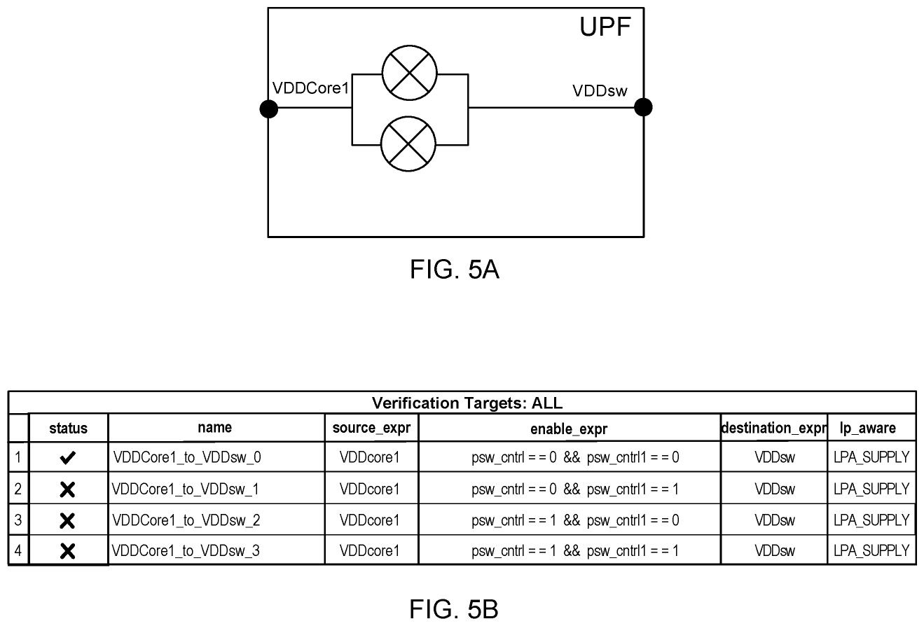

Parallel: There can be multiple unrelated causes for a falsified property. For example, when there are multiple drivers for a supply in UPF, the power intent may provide certain semantics to resolve the conflict between multiple drivers. These semantics are called resolution functions, such as “parallel” and “strong”. For example:
VDDsw and VDDCore1 supplies are connected through two power switches in the UPF with resolution parallel (see FIG. 5A).
Enable expression for one PSW is “!psw_cntrl” and for second power switch is “!psw_cntrl1”.
VDDsw and VDDCore1 connectivity property is falsified when one power switch is OFF and other power switch is ON (see FIG. 5B).
   The formal property for connectivity of VDDsw and VDDCore1 in this example is

add_cc -dest VDDsw -src VDDCore1 -enable {psw_cntrl==0 &&

psw_cntrl1==0} -lpa_type LPA_SUPPLY

In FIG. 5B, two properties failed as one switch is OFF at a given time and the resolution function is parallel.
Parallel cause 1: As one power switch is FULL_ON and the second power switch is OFF, the resolution function “Parallel” makes VDDsw PARTIAL_ON which can be considered FULL_ON or OFF based on the power intent command “set_partial_on_translation”. It is considered OFF by default. User might want to write the resolution function as “STRONG.” “STRONG” resolution ensures that the supply VDDsw is FULL_ON even if one power switch is ON.
Parallel cause 2: “set_partial_on_translation FULL_ON” was missed in the UPF which will infer PARTIAL_ON as FULL_ON and connectivity will be maintained.
   Both causes are independent of each other and can resolve falsification individually.

Speculative: A cause can be speculative in a sense that it might be a potential cause, but the user makes a final decision. For example, as shown in FIG. 5A, VDDsw is driven by two power switches with parallel resolution function. As evident from domain knowledge, a resolution function can make output supply OFF even when only one input supply is OFF. The system may speculate that the resolution function is incorrect.
Speculative cause: As one power switch is FULL_ON and other power switch is OFF, VDDsw becomes PARTIAL_ON which is OFF by default when resolution functions is parallel. User might want to write resolution function as “STRONG.”

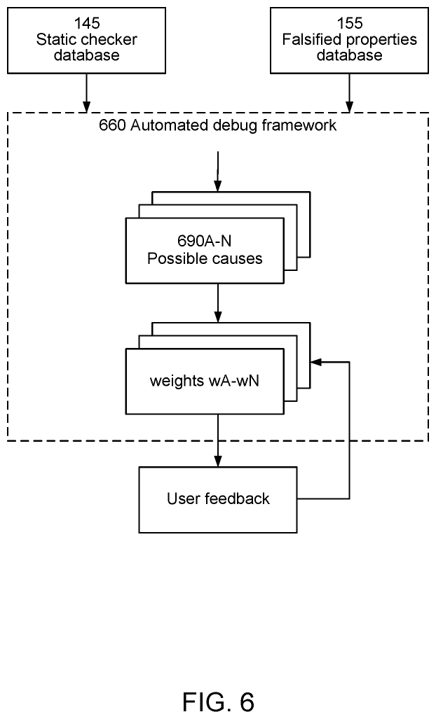

FIG. 6 shows an automated debug framework (ADF) that has the capability to gather and adapt to user feedback whether the cause is correct to debug the property falsification. In this example, the ADF 660 identifies multiple possible causes 690A-N for a particular falsified power-aware formal property. The ADF 660 weights the different possibilities by corresponding weights wA-wN. The ADF may by default to provide equal weights to all of the causes. However, the user may not accept some of these causes. This feedback is cached by the ADF engine 660 with respect to the power-aware property context. This is done by reducing the weight of the causes which have been rejected by the user and/or increasing the weight of the causes which have been accepted by the user. In the future, when similar power-aware property falsification debug arrives, the ADF 660 takes into account the modified weight and can decide not to present a cause based on a threshold on the weight or can prioritize the possible causes based on their weights.

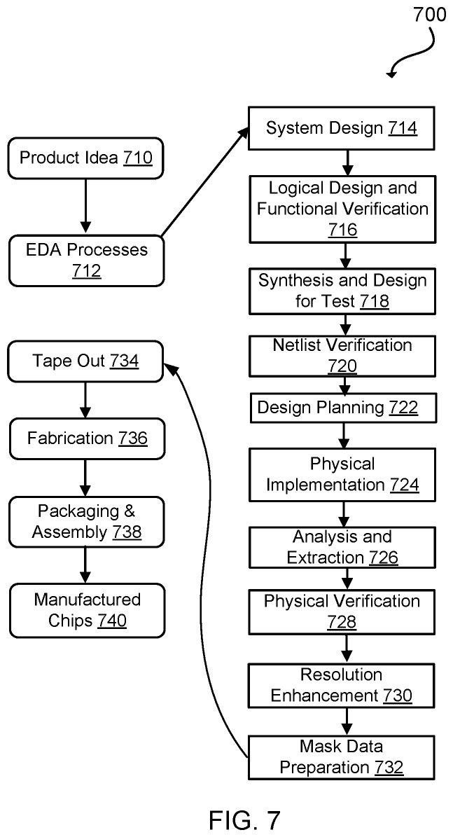

FIG. 7 illustrates an example set of processes 700 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 710 with information supplied by a designer, information which is transformed to create an article of manufacture that uses a set of EDA processes 712. When the design is finalized, the design is taped-out 734, which is when artwork (e.g., geometric patterns) for the integrated circuit is sent to a fabrication facility to manufacture the mask set, which is then used to manufacture the integrated circuit. After tape-out, a semiconductor die is fabricated 736 and packaging and assembly processes 738 are performed to produce the finished integrated circuit 740.

Specifications for a circuit or electronic structure may range from low-level transistor material layouts to high-level description languages. A high-level of abstraction may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower abstraction level that is a less abstract description adds more useful detail into the design description, for example, more details for the modules that include the description. The lower levels of abstraction that are less abstract descriptions can be generated by a computer, derived from a design library, or created by another design automation process. An example of a specification language at a lower level of abstraction language for specifying more detailed descriptions is SPICE, which is used for detailed descriptions of circuits with many analog components. Descriptions at each level of abstraction are enabled for use by the corresponding tools of that layer (e.g., a formal verification tool). A design process may use a sequence depicted in FIG. 7. The processes described by be enabled by EDA products (or tools).

During system design 714, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 716, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 718, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 720, the netlist is checked for compliance with timing constraints and for correspondence with the HDL code. During design planning 722, an overall floor plan for the integrated circuit is constructed and analyzed for timing and top-level routing.

During layout or physical implementation 724, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 726, the circuit function is verified at the layout level, which permits refinement of the layout design. During physical verification 728, the layout design is checked to ensure that manufacturing constraints are correct, such as DRC constraints, electrical constraints, lithographic constraints, and that circuitry function matches the HDL design specification. During resolution enhancement 730, the geometry of the layout is transformed to improve how the circuit design is manufactured.

During tape-out, data is created to be used (after lithographic enhancements are applied if appropriate) for production of lithography masks. During mask data preparation 732, the ‘tape-out’ data is used to produce lithography masks that are used to produce finished integrated circuits.

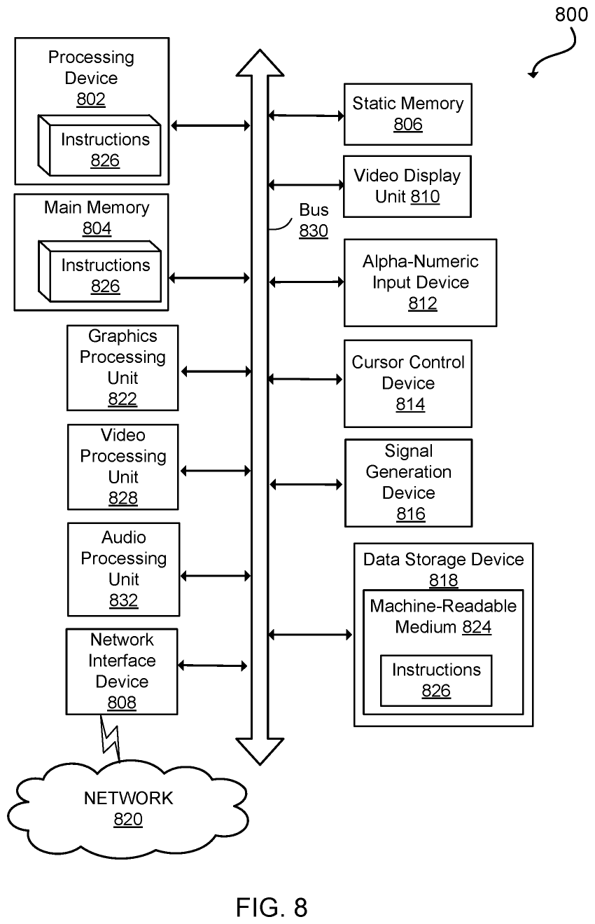

A storage subsystem of a computer system (such as computer system 800 of FIG. 8) may be used to store the programs and data structures that are used by some or all of the EDA products described herein, and products used for development of cells for the library and for physical and logical design that use the library.

FIG. 8 illustrates an example machine of a computer system 800 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processing device 802, a main memory 804 (e.g., read-only memory (ROM), flash memory, dynamic random access memory (DRAM) such as synchronous DRAM (SDRAM), a static memory 806 (e.g., flash memory, static random access memory (SRAM), etc.), and a data storage device 818, which communicate with each other via a bus 830.

Processing device 802 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 may be configured to execute instructions 826 for performing the operations and steps described herein.

The computer system 800 may further include a network interface device 808 to communicate over the network 820. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), a graphics processing unit 822, a signal generation device 816 (e.g., a speaker), graphics processing unit 822, video processing unit 828, and audio processing unit 832.

The data storage device 818 may include a machine-readable storage medium 824 (also known as a non-transitory computer-readable medium) on which is stored one or more sets of instructions 826 or software embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting machine-readable storage media.

In some implementations, the instructions 826 include instructions to implement functionality corresponding to the present disclosure. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 802 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

1. A method comprising:
receiving a falsified power-aware formal property for a design of an integrated circuit; wherein the design comprises multiple power domains, a power intent specification specifies states of the power domains under different conditions, the power-aware formal property describes a desired behavior specified by the power intent specification, and the falsified power-aware formal property indicates that the design does not exhibit the desired behavior;
accessing a debug context database comprising debug contexts for static-check violations resulting from power-aware static checking of the design; wherein power-aware static checking checks for compliance with the power intent specification based on a static structure of the design;
matching, by a processor, the falsified power-aware formal property against the static-check violations; and
generating a data structure that associates debug contexts for the matching static-check violations as possible causes of the falsified power-aware formal property.

2. The method of claim 1, wherein:
the falsified power-aware formal property comprises nodes associated with the falsified power-aware formal property;
the debug context database comprise nodes associated with the static-check violations; and
matching the falsified power-aware formal property against the static-check violations is based on matching the nodes associated with the falsified power-aware formal property against the nodes associated with the static-check violations.

3. The method of claim 2, wherein the nodes associated with the falsified power-aware formal property comprises nodes from the design of the integrated circuit.

4. The method of claim 2, wherein the nodes associated with the static-check violations comprise nodes from the design of the integrated circuit and nodes from the power intent specification.

5. The method of claim 1, further comprising:
pruning the matching static-check violations as possible causes, based on aspects of the falsified power-aware formal property.

6. The method of claim 1, further comprising:
prioritizing the debug contexts as possible causes of the falsified power-aware formal property.

7. The method of claim 6, wherein prioritizing the debug contexts is based on a degree of matching between the falsified power-aware formal property and the static-check violations.

8. The method of claim 6, wherein prioritizing the debug contexts is based on a number of matching nodes between the falsified power-aware formal property and the static-check violations.

9. The method of claim 1, further comprising:
receiving user feedback concerning accuracy of the possible causes; and
adapting the process of matching the falsified power-aware formal property against the static-check violations, based on the user feedback.

10. The method of claim 9, wherein the process of matching the falsified power-aware formal property against the static-check violations is a weighted process, and adapting the process comprises adapting the weights based on the user feedback.

11. A non-transitory computer readable medium comprising stored instructions, which when executed by a processor, cause the processor to perform a method comprising:
matching (a) falsified power-aware formal properties produced by formal verification of a design of an integrated circuit, against (b) static-check violations produced by power-aware static checking of the design; and
annotating the falsified power-aware formal properties with information about the matching static-check violations.

12. The computer readable medium of claim 11, wherein the information annotating the falsified power-aware formal properties comprise possible root causes of the falsified power-aware formal properties.

13. The computer readable medium of claim 11, wherein the information annotating the falsified power-aware formal properties comprise possible hierarchical causes of the falsified power-aware formal properties.

14. The computer readable medium of claim 11, wherein the information annotating the falsified power-aware formal properties comprise possible parallel causes of the falsified power-aware formal properties.

15. The computer readable medium of claim 11, wherein the information annotating the falsified power-aware formal properties comprise possible speculative causes of the falsified power-aware formal properties.

16. An EDA system comprising a memory system storing instructions and a processor system coupled with the memory system to execute the instructions, the EDA system comprising:
a formal verification tool that applies formal verification to power-aware formal properties for a design of an integrated circuit, producing a failed properties database comprising falsified power-aware formal properties;
a static checker tool that applies power-aware static checking to the design, producing a static checker database comprising static-check violations; and
an automated debug framework coupled to access the failed properties database and the static checker database, producing a data structure of possible causes of the falsified power-aware formal properties.

17. The EDA system of claim 16, wherein the automated debug framework is further configured to:
create a debug context database from the static checker database, the debug context database comprising debug contexts for the static-check violations in the static checker database;
match falsified power-aware formal properties against the debug context database; and
pruned and/or prioritize the matched debug contexts from the debug context database.

18. The EDA system of claim 16, wherein the data structure comprises text descriptions of the possible causes of the falsified power-aware formal properties.

19. The EDA system of claim 16, wherein the data structure comprises nodes associated with the possible causes of the falsified power-aware formal properties.

20. The EDA system of claim 16, wherein the design comprises an HDL design of the integrated circuit, a power intent specification comprises a UPF specification of power intent, and the power-aware formal properties and power-aware static checking are based on the power intent specification.
